(19) United States
(12) Patent Application Publication
(10) Pub. No.: US 2026/0228629 A1
(43) Pub. Date: Aug. 6, 2026

(54) Method for an Automated Search for at Least One Suitable Network Architecture for a Machine Learning Application

(71) Applicants: ROBERT BOSCH GmbH, Stuttgart (DE); CARIAD SE, Wolfsburg (DE)

(72) Inventor: Alexander Kugele, Kornwestheim (DE)

(21) Appl. No.: 19/452,084

(22) Filed: Jan. 16, 2026

(30) Foreign Application Priority Data
Jan. 31, 2025 (DE) 102025103730.2

(51) Int. Cl. G06N 20/00; G06F 18/21

(52) U.S. Cl. CPC G06N 20/00; G06F 18/217

(57) ABSTRACT

The invention relates to a method for an automated search for at least one suitable network architecture for a machine learning application, comprising automatically performing the following steps:
Defining a population of architecture proposals for the network architecture,
Determining at least one characteristic feature for at least a part of the architecture proposals, wherein the at least one characteristic feature is specific for the performance of the architecture proposals,
Selecting at least one architecture proposal from the architecture proposals based on the defined population and the determined at least one characteristic feature,
Evaluating the performance of the at least one selected architecture proposal based on a training of the at least one selected architecture proposal,
Determining the at least one suitable network architecture based on the evaluation.

### FIELD OF THE INVENTION

The invention relates to a method for an automated search for at least one suitable network architecture for a machine learning application. Furthermore, the invention relates to a computer program, an apparatus, and a storage medium for this purpose.

### BACKGROUND

In the fields of machine learning (ML) and deep learning (DL), the design of the network architecture poses a fundamental challenge. Selecting the right architecture is crucial for the performance of the neural network in specific tasks, as it directly influences the accuracy and efficiency of the models. The network architecture not only influences the model's ability to capture complex data patterns, but also the training speed and the ability to generalize to unknown data.

Neural Architecture Search (NAS) aims to automate this often time-consuming and complex process. NAS is an automated approach to optimizing network architectures in the field of ML and DL. One goal of NAS is to find the best architectures for specific tasks by automating design decisions that are traditionally made by experts. In doing so, NAS reduces the need for manual trial and error and enables more efficient and powerful architectures.

### SUMMARY

Subject matter of the invention is a method with the features of claim 1, a computer program with the features of claim 10, an apparatus with the features of claim 11, and a computer-readable storage medium with the features of claim 12. Further features and details of the invention follow from the respective subclaims, the description, and the drawings. In this context, features and details which are described in connection with the method according to the invention are also applicable in connection with the computer program according to the invention, the apparatus according to the invention, as well as the computer-readable storage medium according to the invention, and vice versa, so mutual reference is always made or may be made with respect to the individual aspects of the invention.

Subject matter of the invention is, in particular, a method for an automated search for at least one suitable network architecture for an application, in particular a specific application, of machine learning and, preferably, deep learning.

The method may comprise the following steps, which are preferably performed (at least partially or completely) automatically:
Defining a population of architecture proposals for the network architecture, preferably by a digital provision of a data collection,
Determining at least one characteristic feature for at least a part of the architecture proposals, preferably by a digital reading of the feature from at least one data structure and/or matrix that provides the at least one characteristic feature, wherein the at least one characteristic feature may be specific for the performance of the architecture proposals,
Selecting at least one architecture proposal from the architecture proposals based on the defined population and/or the determined at least one characteristic feature, preferably by a digital and/or automated sampling process,
Evaluating the performance of the at least one selected architecture proposal based on a training of the at least one selected architecture proposal, preferably by a digital and/or automated test process, wherein the training may comprise machine training using training and/or validation data,
Determining the at least one suitable network architecture based on the evaluation, which is in particular then respectively provided as a found network architecture, preferably in digital form.

The method according to the invention may make the search for suitable network architectures more efficient and targeted. In particular, the consideration of characteristic features allows a preselection of promising architectures, thereby reducing the computational effort and increasing the efficiency of the search process. The evaluation of the performance based on the training then allows the optimal architecture for the respective application to be determined.

The method according to the invention may be designed to provide a Neural Architecture Search and/or comprise such a search.

In the context of the invention, Neural Architecture Search (NAS) refers in particular to a method that finds architectures based on a specified quality (fitness). In the context of the invention, the quality may be, for example, a weighted combination of several characteristic features such as task performance, runtime, and energy consumption.

Within the NAS, a method may further be used which aims to find the suitable and preferably optimal architecture of a neural network (network architecture) for a specific task. Here, for example, a defined search space is explored using systematic and/or automated methods in order to identify a suitable network topology, considering target specifications defined by at least one characteristic feature, such as runtime, energy efficiency, number of parameters, memory requirements, or performance, measured, for example, in terms of accuracy or F1 score. In general, several methods may be used individually or in combination. These methods comprise, for example, Bayesian optimization, in which the search process is controlled by probabilistic models to make the exploration more efficient. Further, these methods comprise, for example, reinforcement learning, in which a learning agent generates architectures and optimizes them through rewards for better models. Furthermore, the methods comprise, for example, evolutionary algorithms, which iteratively improve architectures through genetic processes such as mutation and selection, and/or gradient-based methods.

NAS may not only search for architectures that provide high performance, but may also consider further important factors such as runtime, energy consumption, and the number of trainable parameters. These additional criteria may be crucial in ensuring that the models developed are not only powerful, but also efficient and sustainable.

By the automation of the architecture design, NAS and, in particular, also the method according to the invention allow for a faster development and optimization of models that may be used in a variety of applications.

Furthermore, the method according to the invention may comprise a selection and evaluation process that is suitable for overcoming at least one disadvantage of the prior art. For example, a disadvantage of conventional NAS methods is that determining or estimating performance is very time-consuming, as it is typically associated with training the network. Many other characteristics, such as runtime or number of parameters, can be measured quickly and easily. At the same time, in practice, one is often limited by the size of the hardware component (e.g., GPU) on which the network is to run. So one wants to find the network with the most parameters that still runs with sufficient performance on the component.

The solution according to the invention may therefore preferably divide the search into two steps: In a first step, networks are sampled and their characteristics are measured. This is often possible at sufficient speed, allowing a large number of architectures to be evaluated. In a second step, it may then be provided that only networks with good characteristics are subsequently trained so that their performance can be determined.

According to a further advantage, it may be provided that the at least one characteristic feature comprises at least one of the following:
runtime,
energy consumption,
energy efficiency,
at least one hyperparameter,
number of parameters,
memory requirements,
computational effort,
robustness,
interpretability,
scalability,
adaptability,
data protection compliance,
security against attacks,
latency,
sustainability,
performance, particularly considering accuracy, F1 score, and/or other relevant performance metrics.

In this way, a selection of architecture proposals may be made that are optimized in terms of both performance and various efficiency metrics. This allows to find network architectures tailored to specific requirements and constraints, e.g., low runtime or low energy consumption.

In a further possibility, it may be provided that the following further step is provided: Updating a pool with further network architectures by means of the determined at least one suitable network architecture in order to provide the pool for training a machine learning model according to at least one of the network architectures of the pool for the application. The pool may, for example, be implemented as a data pool comprising previously searched and/or defined network architectures, preferably also network architectures suitable for the same application. This allows the pool to be expanded and updated with network architectures to ensure a larger selection of options for the training of machine learning models. The integration of the determined suitable network architecture into the pool also allows the performance of the training to be improved based on the latest findings.

Preferably, it may be provided that the selection comprises a search for a quality and, in particular, for characteristics of the architecture proposals, which is/are defined by the at least one characteristic feature. This may serve to find the architecture proposals with the highest suitability according to this quality, and/or to perform the training reduced to these found architecture proposals, and/or to select only these found architecture proposals for further training in order to evaluate the performance of the architecture proposals. In this way, a more efficient training process may be achieved, as the focus is placed on architecture proposals with the best characteristic features. This reduces the number of architectures to be trained and thus the computing time and resources required. The selection is preferably based on a precise evaluation of the quality and specific characteristics of the architecture proposals, which may lead to faster progress in identifying suitable networks for the respective application.

It may be advantageous if, within the scope of the invention, the automated search is performed to find neural networks with high quality for the application. The quality may be defined by the at least one characteristic feature. Furthermore, the application may be a specific application in a technical system, preferably in a vehicle. In this way, it is possible that neural networks with high quality can be developed for specific applications in technical systems, such as vehicles. The definition of the quality by one or more characteristic features allows for a targeted search for optimal network architectures for the respective application.

Furthermore, it may be provided that the selection comprises a multi-objective search (refers to “Mehrzielsuche” in German) with respect to a model performance according to the architecture proposals, in particular at least comprising an accuracy, and a hardware performance of the model, in particular at least comprising latency and/or FLOPS and/or power consumption and/or memory usage. This allows a model to be developed that is both high-performance and efficient on the target hardware.

It is also advantageous if, within the scope of the invention, a part of the characteristic features is initially evaluated based on the training, preferably since their evaluation depends on the training. In this way, it is possible that the evaluation of individual characteristics only takes place after the training, as their determination depends on the results of the training. This may improve the significance of the quality.

Optionally, it is conceivable that the machine learning application comprises an application in a technical system, in particular with a classification of sensor data that has been captured by the technical system. Here, the classification within the scope of the application may be performed on the basis of image points and/or pixels, in particular pixel values, preferably edges or pixel attributes, in particular for object detection. It is therefore possible that the technical system captures sensor data such as images and uses this data for tasks such as object detection with the help of the classified results.

It may also be possible that the machine learning application comprises an application in a technical system in which, based on an output of a machine learning system that is constructed in accordance with at least one of the at least one found network architecture, a control of the technical system is performed, preferably based on a classification based on image points by the machine learning system and/or depending on detected objects. In this way, a control of the technical system may be implemented based on the output of a neural network.

The invention is preferably used to find neural networks with high quality. These networks may then be used in various applications.

For example, the application described in the context of the invention comprises evaluations of digital images, e.g., video data, radar data, LiDAR data, ultrasound data, motion data, thermal image data, or audio signal data. A processing of the data by the neural network may be provided, such as a detection or counting of objects in the data or performing a semantic segmentation of the sensor data, e.g., with respect to traffic signs, a road surface, pedestrians, or vehicles. The processing may specifically be performed on the basis of low-level features, such as edges or pixel attributes for images.

Furthermore, the neural network may be provided for determining one or more continuous values, i.e., for example, for performing a regression analysis, e.g., with respect to a distance, a speed, an acceleration, or a tracking of an object. The neural network may also be used to calculate a control signal for controlling a technical system.

The NAS according to the invention may further represent an upstream part in the tool chain of machine learning. Specifically, it may be used to find hyperparameters that improve network fitness (task performance, runtime, number of parameters, . . . ). The feature search (in particular the step of the selection) and the training loop (in particular the step of the training and/or the evaluation) may be parallelized.

It is possible that the method according to the invention is used in a vehicle. The vehicle may, for example, be designed as a motor vehicle and/or passenger car and/or at least partially automated/autonomous vehicle. The vehicle may comprise a vehicle device, e.g., for providing an autonomous driving function and/or a driver assistance system. The vehicle device may be designed to control and/or accelerate and/or brake and/or steer the vehicle at least partially automatically.

It is possible that, based on the evaluation in the method according to the invention, i.e., particularly with the determined suitable network architecture, a machine learning system is trained and/or tested and/or the trained machine learning system-which comprises the specific network architecture-is used in the application, preferably a deep learning application.

The machine learning system, in particular in the form of a machine learning model, is trained in particular for classification and in particular for object detection. Here, the training may be provided to train the machine learning system or the machine learning model using a training data set for classification, in particular for image classification, of image data such as digital images based on image points and/or pixels, in particular pixel values, preferably edges or pixel attributes (of the image data). The image data or digital images may for example result from a recording from at least one sensor, preferably at least one camera, preferably of a vehicle and particularly preferably of a camera and/or vehicle environment during a journey (of a vehicle). The recording is possible, for example, by at least one camera of the vehicle. The classification may be provided for detecting objects in an environment represented by image data or digital images and/or capturing a traffic scene.

The classification may be provided for various technical applications. One example is the application in a vehicle. Based on the classification, in particular at least one classification result, for example, at least one control action, preferably for a vehicle or for another technical system, may be initiated and/or performed.

Based on the classification result, at least one control action for the vehicle may be initiated and/or performed. The control action may comprise at least one of the following: a brake, a steering, an acceleration, an overtaking maneuver, an emergency brake, an activation of an alarm system, an activation of a hazard warning light, an activation of a turn signal, a light control, or the like.

The “classification” may also comprise an “object detection.” This refers in particular to a classification of whether or not objects are present in certain areas of the image. In addition, the term “classification” may also refer to “semantic segmentation”, particularly in the form of pixel-by-pixel classification.

Accordingly, from the training, at least one trained machine learning model (i.e., a machine learning system) may result, which may be used for the classification and/or object detection. The use and thus the inference may be provided, for example, in a vehicle and/or robot and/or in another technical system. The data points of the input data may be, for example, pixels of image data or be based on these in order to perform the classification and/or object detection of the data points on the basis of the pixels. The input data may comprise sensor and/or image data which at least partially results from detection by a sensor, preferably a camera sensor, and/or which is at least partially synthesized, meaning in particular that it replicates the real data of a sensor. Specifically, it may be provided that by the values of image points, preferably pixels, of the image data, an environment of a sensor and/or a vehicle and/or a traffic scene is represented. A classification, preferably image classification and/or object detection, may be provided on the basis of these values. The image data may be, for example, images from a radar sensor and/or an ultrasonic sensor and/or a LiDAR sensor and/or a thermal imaging camera. Accordingly, the images may also be radar images and/or ultrasonic images and/or thermal images and/or LiDAR images.

The invention also relates to a computer program, in particular a computer program product, comprising instructions which, when the computer program is executed by at least one computer, cause the computer to carry out the method according to the invention. The computer program according to the invention thus provides the same advantages as those described in detail with reference to a method according to the invention.

The invention also relates to a data processing apparatus which is configured to execute the method according to the invention. At least one computer that executes the computer program according to the invention may be provided as the apparatus. The computer may comprise at least one processor for executing the computer program. Also, a non-volatile data memory may be provided in which the computer program may be stored and from which the computer program may be read by the processor for being carried out.

The invention may also relate to a computer-readable storage medium which comprises the computer program according to the invention and/or instructions which, when executed by at least one computer, cause the computer to carry out the method according to the invention. The storage medium is, for example, designed as a data memory such as a hard disk and/or a non-volatile memory and/or a memory card. The storage medium may be integrated into the computer, for example.

Furthermore, the method according to the invention may also be implemented as a computer-implemented method. Alternatively or additionally, at least one of the disclosed method steps may be computer-implemented and/or performed automatically.

### BRIEF DESCRIPTION OF THE DRAWINGS

Further advantages, features, and details of the invention are apparent from the following description, in which embodiments of the invention are described in detail with reference to the drawings. In this context, the features mentioned in the claims and in the description may be essential to the invention individually or in any combination. Shown are:

FIG. 1 a schematic visualization of a method, an apparatus, a storage medium, and a computer program according to embodiments of the invention.

FIG. 2 a schematic representation of embodiments of the invention.

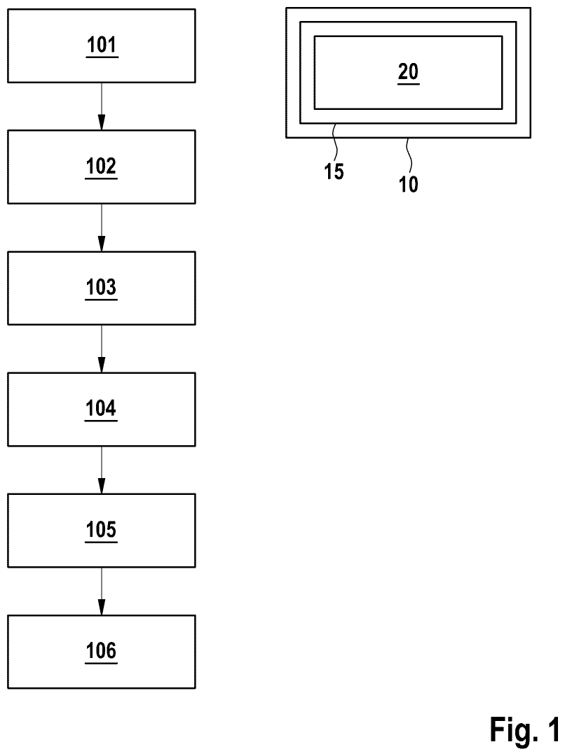

In FIG. 1, a method 100, an apparatus 10, a storage medium 15, and a computer program 20 according to embodiments of the invention are shown schematically.

FIG. 1 also illustrates, according to embodiments of the invention, the application of the method 100 for an automated search for at least one suitable network architecture for a machine learning application.

### DETAILED DESCRIPTION

According to a first method step 101, a defining of a population of architecture proposals for the network architecture may be provided, preferably by a reading out of a pool from a digital data storage. According to a second method step 102, then at least one characteristic feature for at least a part of the architecture proposals may be determined, preferably also by a reading out from a digital data storage. Here, the at least one characteristic feature may be specific for the performance of the architecture proposals.

Then, according to a third method step 103, at least one architecture proposal may be selected from the architecture proposals based on the defined population and the determined at least one characteristic feature, preferably according to a predefined selection criterion, such as, for example, a quantitative minimum match and/or a threshold value comparison and/or the like.

Then, in a fourth method step 104, the performance of the at least one selected architecture proposal may be evaluated based on training of the at least one selected architecture proposal. This enables, in a fifth method step 105, a determination of the at least one suitable network architecture based on the evaluation 104.

According to a further optional sixth method step 106, an update 106 of a pool with further network architectures by the determined at least one suitable network architecture may be provided in order to provide the pool for a training of a machine learning model according to at least one of the network architectures of the pool for the application.

The method according to embodiments of the invention allows to find networks with good characteristics much more quickly, since the time-consuming training of the networks is outsourced to a second step.

Concrete implementations of NAS with fundamentally different approaches are known, for example, from the publication “NAS via Bayesian Optimization, James Bergstra, Dan Yamins, and David D. Cox. Making a science of model search: Hyperparameter optimization in hundreds of dimensions for vision architectures. ICML, 2013”. This work describes the application of Bayesian optimization for the efficient search for optimal network architectures.

Another well-known implementation of NAS is based on reinforcement learning and was described in the publication “NAS via Reinforcement Learning, Bowen Baker, Otkrist Gupta, Nikhil Naik, and Ramesh Raskar. Designing neural network architectures using reinforcement learning. International Conference on Learning Representations, 2017a”.

Furthermore, the publications “NAS as sequential decision process, Han Cai, Tianyao Chen, Weinan Zhang, Yong Yu, and Jun Wang. Efficient architecture search by network transformation. Association for the Advancement of Artificial Intelligence, 2018a.” and “NAS via evolutionary algorithms, G. F. Miller, P. M. Todd, and S. U Hedge. Designing neural networks using genetic algorithms. 3rd International Conference on Genetic Algorithms (ICGA'89), 1989” are also known from the state of the art.

The solution according to embodiments of the invention may be based at least in part on the described implementations of NAS.

Embodiments of the invention also allow, among other things, to perform a more accurate search than is possible with conventional solutions. In typical NAS approaches, the search space often has to be severely restricted before the search begins, as the search itself would otherwise become too costly. In comparison, the search for good characteristics is faster.

For example, in this way it is in principle possible to also include individual hyperparameters, such as the number of neurons in each layer, in the search space. This has practical relevance, as illustrated by the following example. If, for example, the vocab size in the GPT is not set optimally, unnecessary runtime losses occur.

Embodiments of the invention may provide a multi-objective search with regard to model performance (e.g., accuracy, etc.) and the hardware performance of the model (e.g., latency, FLOPS (floating point operations per second), power consumption, memory usage). Here, in the first and second phases (feature search and task suitability search), NAS methods may be applied.

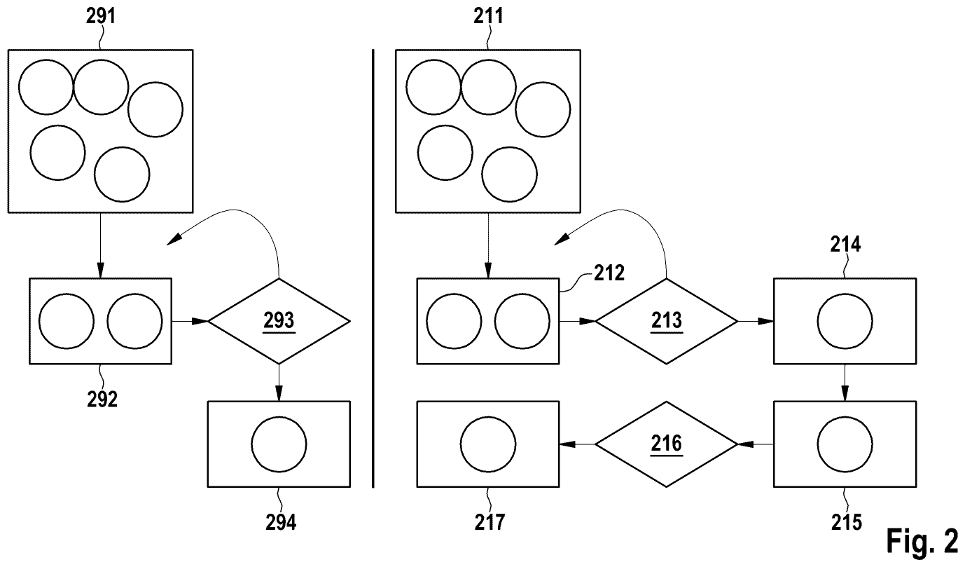

In FIG. 2, several steps are shown that are also provided for in conventional NAS methods. In such methods, it is often provided that first a population of possible neural networks is defined, some of which are trained (see 292), and depending on the result of the training and the resulting fitness criteria 293, the best models are selected and the pool is updated accordingly (see 294).

In addition, FIG. 2 shows the additional steps 211-217, which are provided for in embodiments of the invention. An (artificial) neural network is abbreviated as “NN.”

First, a population of architectures may be defined (see 211). This set of possible neural networks (NN) may be determined, for example, on the basis of a list of ranges of different hyperparameters:
layer1: hidden_size between 10 and 100;
layer2: hidden_size between 100 and 1000; . . .
   or also comprise different block structures:
linear layer, transformer layer, cnn layer, . . .

A combination of corresponding or similar specifications is also possible in order to define the population of the architectures.

Subsequently, architectures may be selected from the population using an algorithm (e.g., NAS-based, see steps 291-294, or random) (see 212).

The characteristics of the selected architectures may then be measured and the suitable architectures may be selected (see 213). The selection of suitable architectures, i.e., the selected architectures with good characteristics, may be done, for example, by comparing them with predefined criteria, such as the type of runtime or the number of parameters. These may be hyperparameters that are known to improve network fitness, as is also known for conventional NAS methods.

The pool of architectures with good characteristics may then be updated (see 214).

The next step may be performed either in parallel or sequentially. Here, the architectures with good characteristics are trained to determine their task performance (see 215). Only on the basis of the training can certain criteria such as accuracy and runtime behavior be finally evaluated, which then determine the network fitness.

A second pool of good models may then be updated (see 217) if, based on the evaluation in step 216, it is determined that the model should be better than the models in the pool.

Optionally, the selection of the models (see 213 and 216) may also be improved by a feedback loop.

The above description of the embodiments describes the present invention exclusively in the context of examples. Of course, individual features of the embodiments can be freely combined with each other, if technically sensible, without leaving the scope of the present invention.

1. A method for an automated search for at least one suitable network architecture for a machine learning application, comprising automatically performing the following steps:
Defining a population of architecture proposals for the network architecture,
Determining at least one characteristic feature for at least a part of the architecture proposals, wherein the at least one characteristic feature is specific for the performance of the architecture proposals,
Selecting at least one architecture proposal from the architecture proposals based on the defined population and the determined at least one characteristic feature,
Evaluating the performance of the at least one selected architecture proposal based on a training of the at least one selected architecture proposal,
Determining the at least one suitable network architecture based on the evaluation.

2. The method according to claim 1, characterized in that the at least one characteristic feature comprises at least one of the following: runtime, energy consumption, energy efficiency, at least one hyperparameter, number of parameters, memory requirements, computational effort, robustness, interpretability, scalability, adaptability, data protection compliance, security against attacks, latency, sustainability, performance, accuracy, F1 score, and/or other performance metrics.

3. The method according to claim 1,
characterized in that the following further step is provided:
Updating a pool with further network architectures by means of the determined at least one suitable network architecture in order to provide the pool for training a machine learning model according to at least one of the network architectures of the pool for the application.

4. The method according to claim 1,
characterized in that the selection comprises a search for a quality, which is defined by the at least one characteristic feature, in order to find the architecture proposals with the highest suitability according to this quality, and to perform the training reduced to these found architecture proposals and/or to select only these found architecture proposals for further training in order to evaluate the performance of the architecture proposals.

5. The method according to claim 1,
characterized in that the automated search is performed to find neural networks with high quality for the application, wherein the quality is defined by the at least one characteristic feature, wherein the application is a specific application in a technical system.

6. The method according to claim 1,
characterized in that the selection comprises a multi-objective search with respect to a model performance according to the architecture proposals.

7. The method according to claim 1,
characterized in that a part of the characteristic features is initially evaluated based on the training, since their evaluation depends on the training.

8. The method according to claim 1,
characterized in that the application of machine learning comprises an application in a technical system, with a classification of sensor data that has been captured by the technical system, wherein the classification is performed on the basis of image points and/or pixels.

9. The method according to claim 1,
characterized in that the machine learning application comprises an application in a technical system in which, based on an output of a machine learning system that is constructed in accordance with at least one of the at least one found network architecture, a control of the technical system is performed.

10. (canceled)

11. A data processing apparatus comprising:
one or more processors; and
a computer program comprising instructions stored on a non-transitory computer-readable storage medium, the instructions which when executed by the one or more processors cause the one or more processors to:
define a population of architecture proposals for the network architecture,
determine at least one characteristic feature for at least a part of the architecture proposals, wherein the at least one characteristic feature is specific for the performance of the architecture proposals,
select at least one architecture proposal from the architecture proposals based on the defined population and the determined at least one characteristic feature,
evaluate the performance of the at least one selected architecture proposal based on a training of the at least one selected architecture proposal,
determine the at least one suitable network architecture based on the evaluation.

12. A non-transitory computer-readable storage medium, comprising instructions which, when executed by at least one computer, cause the computer to:
define a population of architecture proposals for the network architecture,
determine at least one characteristic feature for at least a part of the architecture proposals, wherein the at least one characteristic feature is specific for the performance of the architecture proposals,
select at least one architecture proposal from the architecture proposals based on the defined population and the determined at least one characteristic feature,
evaluate the performance of the at least one selected architecture proposal based on a training of the at least one selected architecture proposal,
determine the at least one suitable network architecture based on the evaluation.

13. The method according to claim 4 wherein the search for a quality comprises a search for characteristics of the architecture.

14. The method according to claim 5 wherein the technical system is in a vehicle.

15. The method according to claim 6 wherein at least one of:
(a) the model performance according to the architecture proposals comprises at least an accuracy, and a hardware performance of the model; or
(b) the model performance according to the architecture proposals comprises at least latency and/or FLOPS and/or power consumption and/or memory usage.

16. The method according to claim 8 wherein at least one of:
(a) the basis of image points and/or pixels comprises particular pixel values comprising edges or pixel attributes; or
(a) the classification is performed on the basis of image points and/or pixels for object detection.

17. The method according to claim 9 wherein control of the technical system is performed based on image points by the machine learning system and/or depending on detected objects.

18. The method according to claim 9 wherein control of the technical system is performed based on image points by the machine learning system and/or depending on detected objects.
